(19) United States
(12) Patent Application Publication
(10) Pub. No.: US 2018/0270734 A1
(43) Pub. Date: Sep. 20, 2018

(54) SYSTEMS AND METHODS FOR RELAYING AN UPDATE TO A TARGET ELECTRONIC DISPLAY LABEL

(71) Applicant: QUALCOMM Incorporated, San Diego, CA (US)

(72) Inventor: Rajasekaran KALIDOSS, Mayiladuthurai (IN)

(21) Appl. No.: 15/461,460

(22) Filed: Mar. 16, 2017

(51) Int. Cl. H04W 40/22; H04W 4/00; G06F 3/14

(52) U.S. Cl. CPC H04W 40/22; H04W 84/12; G06F 3/1423; H04W 4/008

(57) ABSTRACT

Disclosed are systems and methods for relaying an update to a target electronic display device within a venue. In an aspect, an access terminal component of a bridge communication device receives the update for the target electronic display device from a wireless local area network (WLAN) access point of the venue, wherein the target electronic display device is one of a plurality of electronic display devices within the venue, wherein the plurality of electronic display devices form a low-energy mesh network, and wherein each electronic display device comprises a low-energy short-range wireless network component coupled to an electronic display. A low-energy short-range wireless network component of the bridge communication device sends the update to at least a first electronic display device of the plurality of electronic display devices, and the update is relayed over the low-energy mesh network from at least the first electronic display device to the target electronic display device.

### BACKGROUND

### 1. Field of the Disclosure

Aspects relate to systems and methods for relaying an update to a target electronic display label.

### 2. Description of the Related Art

More and more, paper labels are being replaced by electronic display labels (also referred to as “electronic shelf labels”), especially in locations where large numbers of items/products are displayed for sale. Generally, electronic display labels are attached to the front edge of retail shelving and convey information such as the name, brand, price, expiration date, etc. of the corresponding items/products.

The information on electronic display labels may need to be updated frequently. For example, in a large supermarket, there may be thousands of electronic display labels that need to be updated as products go on sale, sell out, inventory changes, etc. Electronic display labels are often connected to some sort of communication network that allows the displayed information to be updated. However, available solutions for updating electronic display labels are energy intensive and are not cost-effective.

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of relaying an update to a target electronic display device within a venue includes receiving, at an access terminal component of a bridge communication device, the update for the target electronic display device from a wireless local area network (WLAN) access point of the venue, wherein the target electronic display device is one of a plurality of electronic display devices within the venue, wherein the plurality of electronic display devices form a low-energy mesh network, and wherein each of the plurality of electronic display devices comprises a low-energy short-range wireless network component coupled to an electronic display, and sending, by a low-energy short-range wireless network component of the bridge communication device, the update to at least a first electronic display device of the plurality of electronic display devices within the venue, wherein the update is relayed over the low-energy mesh network from at least the first electronic display device to the target electronic display device.

In an aspect, a bridge communication device for relaying an update to a target electronic display device within a venue includes an access terminal component configured to receive the update for the target electronic display device from a WLAN access point of the venue, wherein the target electronic display device is one of a plurality of electronic display devices within the venue, wherein the plurality of electronic display devices form a low-energy mesh network, and wherein each of the plurality of electronic display devices comprises a low-energy short-range wireless network component coupled to an electronic display, and a low-energy short-range wireless network component configured to send the update to at least a first electronic display device of the plurality of electronic display devices within the venue, wherein the update is relayed over the low-energy mesh network from at least the first electronic display device to the target electronic display device.

In an aspect, a non-transitory computer-readable medium storing computer-executable instructions for relaying an update to a target electronic display device within a venue includes computer-executable instructions comprising at least one instruction to cause an access terminal component of a bridge communication device to receive the update for the target electronic display device from a WLAN access point of the venue, wherein the target electronic display device is one of a plurality of electronic display devices within the venue, wherein the plurality of electronic display devices form a low-energy mesh network, and wherein each of the plurality of electronic display devices comprises a low-energy short-range wireless network component coupled to an electronic display, and at least one instruction to cause a low-energy short-range wireless network component of the bridge communication device to send the update to at least a first electronic display device of the plurality of electronic display devices within the venue, wherein the update is relayed over the low-energy mesh network from at least the first electronic display device to the target electronic display device.

Other objects and advantages associated with the aspects disclosed herein will be apparent to those skilled in the art based on the accompanying drawings and detailed description.

### BRIEF DESCRIPTION OF THE DRAWINGS

A more complete appreciation of aspects of the disclosure will be readily obtained as the same becomes better understood by reference to the following detailed description when considered in connection with the accompanying drawings which are presented solely for illustration and not limitation of the disclosure, and in which:

FIG. 1 illustrates an exemplary system 100 according to at least one aspect of the disclosure.

FIGS. 2A and 2B illustrate exemplary communication flows among various devices illustrated in FIG. 1, according to at least one aspect of the disclosure.

FIG. 3 illustrates an exemplary access point-to-mesh network bridge device according to at least one aspect of the disclosure.

FIG. 4 illustrates an exemplary electronic display label device according to at least one aspect of the disclosure.

FIG. 5 illustrates an exemplary flow for relaying an update to a target electronic display device within a venue.

FIG. 6 is a simplified block diagram of several sample aspects of an apparatus configured to support communication as taught herein.

### DETAILED DESCRIPTION

Disclosed are systems and methods for relaying an update to a target electronic display device within a venue. In an aspect, an access terminal component of a bridge communication device receives the update for the target electronic display device from a wireless local area network (WLAN) access point of the venue, wherein the target electronic display device is one of a plurality of electronic display devices within the venue, wherein the plurality of electronic display devices form a low-energy mesh network, and wherein each of the plurality of electronic display devices comprises a low-energy short-range wireless network component coupled to an electronic display. A low-energy short-range wireless network component of the bridge communication device sends the update to at least a first electronic display device of the plurality of electronic display devices, and the update is relayed over the low-energy mesh network from at least the first electronic display device to the target electronic display device.

These and other aspects of the disclosure are disclosed in the following description and related drawings directed to specific aspects of the disclosure. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As noted above, the information on electronic display labels may need to be updated frequently. For example, in a large supermarket, there may be thousands of electronic display labels that need to be updated as products go on sale, sell out, inventory changes, etc. Electronic display labels are often connected to some sort of communication network that allows the displayed information to be updated. However, available solutions for updating electronic display labels are energy intensive and are not cost-effective.

Accordingly, the present disclosure provides a low-cost, low-energy solution for relaying updates to target electronic display labels. The system of the present disclosure includes a plurality of electronic display label (EDL) devices, a wireless local area network (WLAN) access point, and an access point-to-mesh network bridge (AMB) device connected to both the WLAN access point and the plurality of EDL devices. The plurality of EDL devices and the AMB device form a low-energy mesh network. Each EDL device comprises a low-energy short-range wireless network device, such as, but not limited to, a Bluetooth Low-Energy (BLE) device (also referred to as Bluetooth Smart™), that acts as a “node” of the low-energy mesh network. Each AMB device may act as both an access terminal to the WLAN access point and as a low-energy short-range wireless network node in the low-energy mesh network. There may be many (e.g., tens, hundreds) of AMB devices, and thereby low-energy mesh networks, connected to a single WLAN access point, limited only by the range and capacity of the WLAN access point. Where the system of the present disclosure is deployed within a venue, such as a large retail venue, or retail venues with very large numbers of EDL devices, there may be multiple WLAN access points serving a large number of low-energy mesh networks within the venue.

Each WLAN access point may be connected to a server, which may be either local or remote to the venue. In operation, updates to information displayed on specific ones of the EDL devices deployed at a venue may be sent from the server to the appropriate WLAN access point(s) (i.e., the WLAN access point(s) connected via AMB device(s) to the target EDL devices). The WLAN access point sends the updated information to the AMB devices to which it is connected, and each AMB device checks to see if the received information is for an EDL device in its low-energy mesh network. If it is, then the AMB device sends the received information to the target EDL device via the low-energy mesh network. The receiving EDL device then updates its display with the received information.

Where the system of the present disclosure is deployed at a retail venue, the updated information may include information such as price, brand, expiration date, and the like. In such an implementation, each rack of an aisle in the retail venue may have an AMB device, and each EDL device on a rack may form a low-energy mesh network with the AMB device. While there may be any number of EDL devices connected to a single AMB device, the more EDL devices connected to a single AMB device, the longer the propagation delay from the AMB device to the last EDL device in the chain.

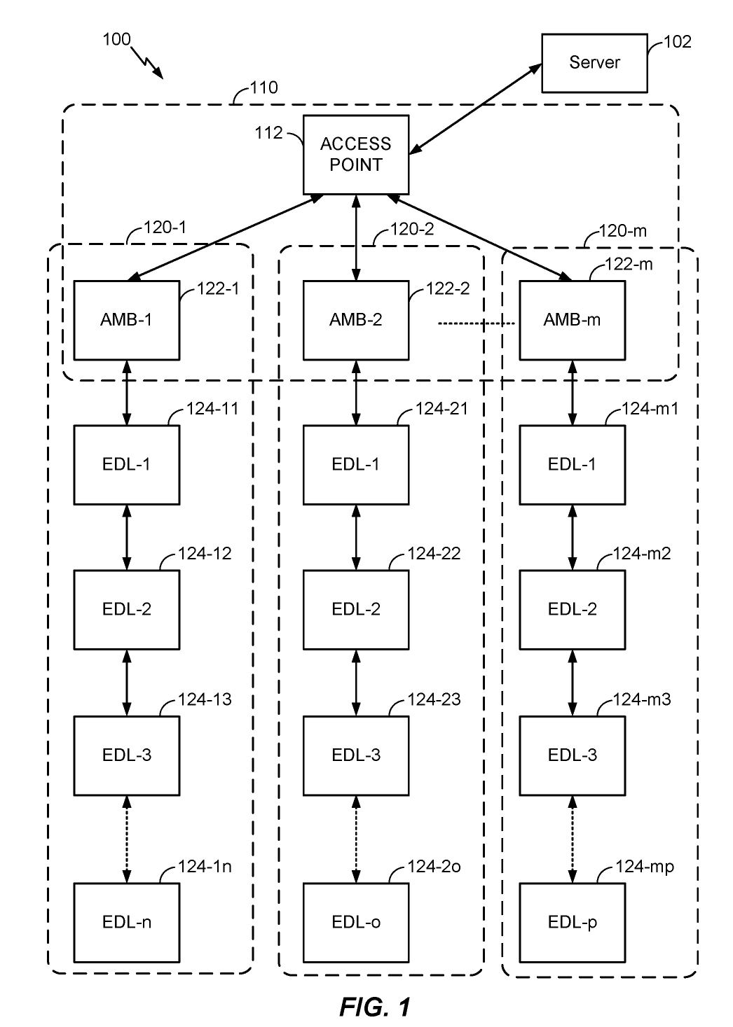

FIG. 1 illustrates an exemplary system 100 according to at least one aspect of the disclosure. The system 100 includes a WLAN 110 and a plurality of low-energy mesh networks 120-1 to 120-m, collectively referred to as low-energy mesh networks 120. The WLAN 110 may include one or more WLAN access points 112 that are communicatively coupled to one or more servers 102. In an aspect, the WLAN 110 may be a WiFi network (i.e., a wireless network in accordance with the Institute of Electrical and Electronics Engineers (IEEE) 802.11 specification) and the one or more WLAN access points 112 may be one or more WiFi access points. The one or more WLAN access points 112 may communicate with the one or more servers 102 via a wired or wireless connection, such as a WiFi connection, an Ethernet connection, a cable internet connection, an optical internet connection, or the like.

The low-energy mesh networks 120 include a plurality of EDL devices 124. Specifically, the low-energy mesh network 120-1 includes EDL devices 124-11 to 124-1n, the low-energy mesh network 120-2 includes EDL devices 124-21 to 124-2o, and the low-energy mesh network 120-m includes EDL devices 124-m1 to 124-mp. The various EDL devices illustrated in FIG. 1 are collectively referred to as EDL devices 124. As will be described further herein, the EDL devices 124 may each be, or may each include, a low-energy short-range wireless network device, such as a BLE device, that acts as a “node” of the corresponding low-energy mesh network 120. As will be appreciated, the system 100 may include more or fewer than the number of EDL devices 124 illustrated in FIG. 1.

The system 100 further includes a plurality of AMB devices 122-1 to 122-m, collectively referred to as AMB devices 122. As will be described further herein, each AMB device 122 may act as both an access terminal to the WLAN access point 112 and as a low-energy short-range wireless network node in the corresponding low-energy mesh network 120. Thus, as illustrated by the dashed lines in FIG. 1, AMB device 122-1 is a member of both the WLAN 110 and the low-energy mesh network 120-1, AMB device 122-2 is a member of both the WLAN 110 and the low-energy mesh network 120-2, and AMB device 122-m is a member of both the WLAN 110 and the low-energy mesh network 120-m. As will be described further herein, an AMB device 122 acts as a bridge between the WLAN access point 112 and the EDL devices 124 to which it is connected. Specifically, referring to the example of FIG. 1, AMB device 122-1 may act as a bridge between the WLAN access point 112 and EDL devices 124-11 to 124-1n, AMB device 122-2 may act as a bridge between the WLAN access point 112 and EDL devices 124-21 to 124-2o, and AMB device 122-m may act as a bridge between the WLAN access point 112 and EDL devices 124-m1 to 124-mp. As will be appreciated, the system 100 may include more or fewer than the number of AMB devices 122 illustrated in FIG. 1. Additionally, different AMB devices 122 may be connected to different numbers of EDL devices 124.

In an aspect, the one or more WLAN access points 112, the AMB devices 122, and the EDL devices 124 may be located within a particular venue (e.g., a retail store). The one or more servers 102 may also be located within the venue, or may be remote to the venue and connected to the one or more WLAN access points 112 over the Internet (e.g., a “cloud” based server). For example, where the server 102 is a local server, it may be a cellular phone, a tablet computer, a laptop computer, a desktop computer, or similar device, running an application (or “app”) that enables the server 102 to send updated information for the EDL devices 124 to the WLAN access points 112. Where the server 102 is a remote server, it may be accessible via a webpage that allows a user to enter updated information for the EDL devices 124.

A mesh network, such as low-energy mesh networks 120, is a network topology in which each node (e.g., EDL devices 124) relays data for the network. Mesh networks can relay data packets using either a flooding technique or a routing technique. With routing, data packets are propagated along a particular path by hopping from node to node until the data packets reach their destination (i.e., a target node). With flooding, an incoming data packet is sent through every outgoing connection except the one on which it arrived. That is, when a node receives a data packet, if it is not intended for that node, or for only that node, the node forwards the data packet to all other nodes to which it is connected except the node from which it received the data packet. The node from which a data packet is received is referred to herein as the “uplink” node. Nodes to which a data packet is sent are referred to herein as “downlink” nodes.

The flooding technique has advantages over the routing technique. For example, with the flooding technique, adding or removing nodes in the mesh network does not require any management, as there are no specific routes that data packets must follow through the mesh network. Rather, as noted above, each node passes all incoming data packets to every other node to which it is connected; no hub or WLAN access point is required to manage the nodes.

An example of a mesh network that utilizes the flooding technique is a QCSR Mesh™ network available from Qualcomm®. It is often utilized for home automation, such as lighting control, heating, access, etc. The nodes of a QCSR Mesh™ network are BLE devices. Thus, a QCSR Mesh™ network uses BLE advertise and scan mechanisms to pass data packets from node to node. More specifically, a BLE device that is attempting to initiate a connection with another BLE device (referred to as an “advertiser”) broadcasts an advertising packet during an advertising window and then listens for a response during a corresponding listen window. A BLE device that is not attempting to initiate a connection with another BLE device (referred to as a “scanner”) scans for incoming advertising packets during a periodic scan window. As is known in the art, to reduce battery consumption, a BLE device may alternate between advertising in an advertising window, sleeping for a period of time, and scanning in a scan window, such that the BLE device is periodically advertising, periodically scanning, and periodically sleeping. If a BLE device acting as a scanner detects an advertising packet during a scan window, then, to establish a connection between the advertiser and the scanner BLE devices, the scanner replies to the advertiser with a request packet, and the advertiser replies back to the scanner with a response packet. After the connection is established, the advertiser BLE device can transmit data packets to the scanner BLE device over the established communication link.

In a QCSR Mesh™ network, the communication between nodes (i.e., BLE devices) is encrypted on a per packet basis, allowing only members of the network to understand the data. A network key used for this encryption is generated from a pass phrase on a mesh controller and is securely distributed from the mesh controller to the nodes. Infinite retransmissions are prevented by not relaying data packets that have already been heard and by using a time-to-live counter.

New nodes in a QCSR Mesh™ network are assigned a unique identifier, which is typically a 16 bit number. In addition, each node can be assigned to one or more groups, where the number of groups to which a node can belong is configurable. Similarly, each node can implement one or more roles, which are referred to as models and clients. Specifically, a model is a receiver of a command that the client sends. For example, a light fixture model may receive data packets from a light switch client instructing the light fixture model to turn on or off.

A QCSR Mesh™ network is an attractive implementation of a mesh network, as it is fast, secure, needs very little management, and is power efficient for battery driven devices. Thus, in an aspect, the low-energy mesh network 120 may be a QCSR Mesh™ network. As such, in this aspect, the low-energy short-range wireless network devices of the EDL devices 124 would be BLE devices.

QCSR Mesh™ is designed for shorter data packets (approximately 14 bytes). In a retail venue implementation, where updated information is propagated to specific EDL devices 124, the update information for an EDL device 124 would likely be short enough to fit into the shorter QCSR Mesh™ network data packets. The chances of needing a larger data packet (e.g., larger than 14 bytes) are rare. However, in that case, the update information can be split into smaller chunks and sent in multiple data packets. For example when there are multiple fields to be updated (e.g., brand name, product name, etc.), each field can be sent as a separate data packet.

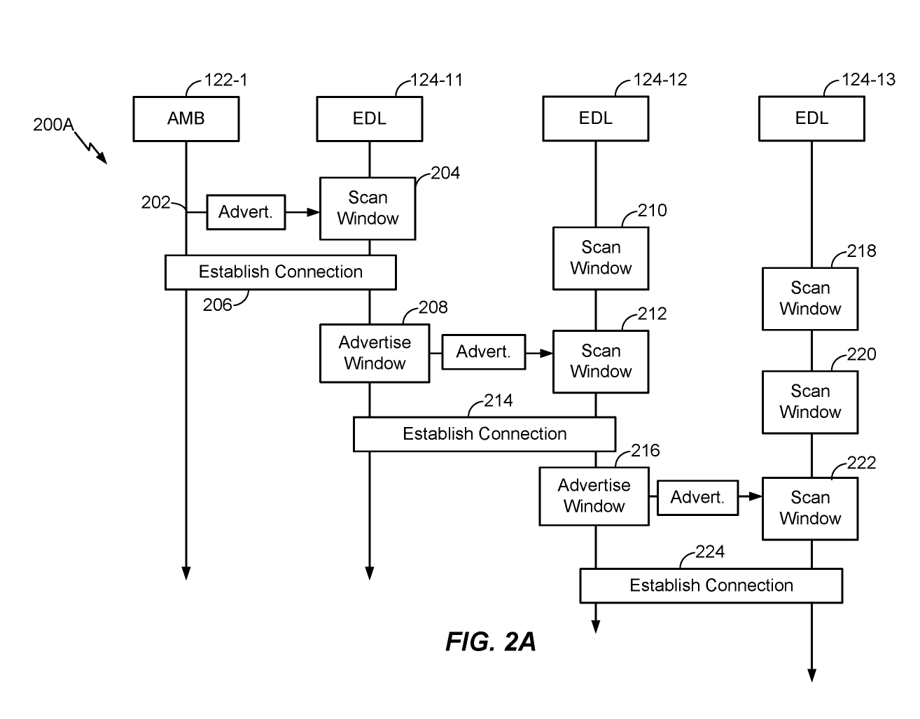

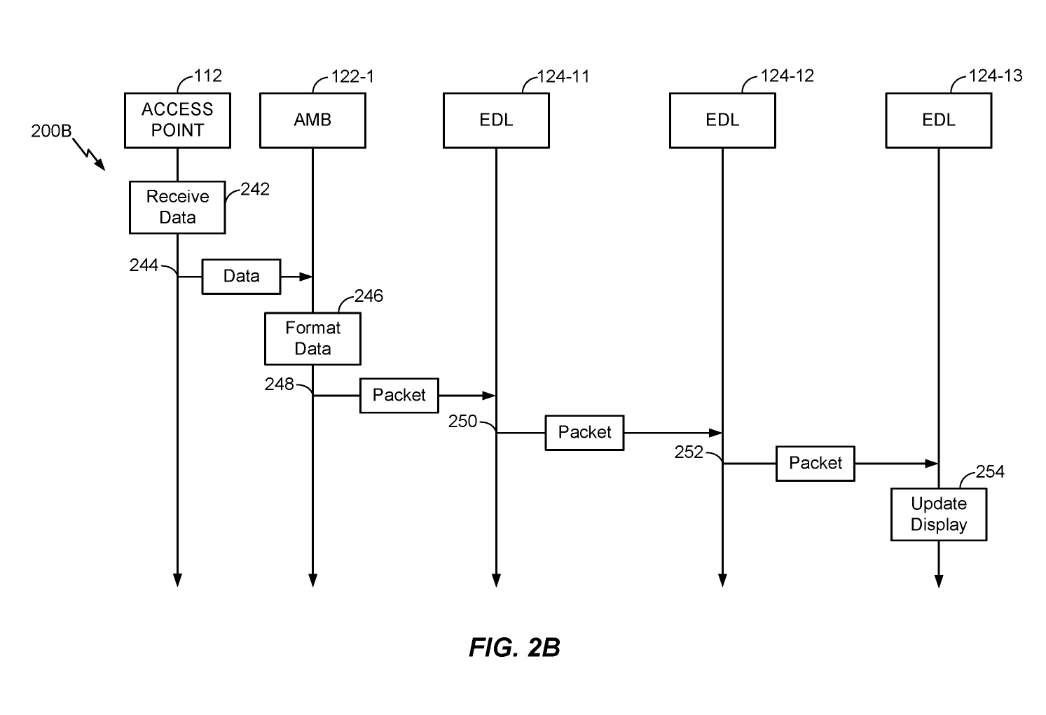

FIG. 2A illustrates an exemplary flow 200A for establishing a low-energy mesh network among various devices illustrated in FIG. 1, according to at least one aspect of the disclosure. Specifically, FIG. 2A illustrates the establishment of the low-energy mesh network 120-1 of FIG. 1 among the AMB device 122-1 and EDL devices 124-11 to 124-13.

The AMB device 122-1 acts as an on-boarding device with respect to the EDL devices 124. More specifically, the AMB device 122-1 initially scans for and selects the EDL devices 124 that will form the low-energy mesh network 120-1, here, EDL devices 124-11 to EDL devices 124-1n, although for simplicity, only EDL devices 124-11 to 124-13 are illustrated in FIG. 2A. For example, during deployment, the AMB device 122-1 can enter a configuration mode in which it scans for EDL devices and sends connection requests to each of them to form the low-energy mesh network 120-1. In that way, the AMB device 122-1 will have a list of the EDL devices that are part of the low-energy mesh network 120-1. When a new EDL device needs to be added to the low-energy mesh network 120-1 after this initial deployment, the AMB device 122-1 can be configured to scan for and add the new EDL device(s), or the new ADL(s) can be added to the AMB device 122-1's list manually by a control interface of the AMB device 122-1.

Referring to FIG. 2A, at 202, the low-energy short-range wireless network device side of the AMB device 122-1 (which may be a BLE device) starts broadcasting advertising packets during an advertising window in order to establish a connection with all in-range low-energy short-range wireless network devices, i.e., EDL device 124-11. Where the EDL devices 124 are BLE devices, the EDL device 124-11 may scan for incoming advertising packets during periodic scan windows, as discussed above. Thus, at 204, the EDL device 124-11 receives the advertising packet from the low-energy short-range wireless network device side of the AMB device 122-1 during a periodic scan window. At 206, the low-energy short-range wireless network device side of the AMB device 122-1 establishes a low-energy mesh network connection with the EDL device 124-11.

Note that in the example of FIGS. 1 and 2A, the AMB device 122-1 is only connected to one other downlink low-energy short-range wireless network device, i.e., EDL device 124-11. However, as will be appreciated, the AMB device 122-1 (and any of the AMB devices 122) may be connected to more than one downlink EDL device 124 (note that because the AMB device 122 is a bridge device, any EDL device 124 to which an AMB device 122 is connected is a downlink EDL device 124).

After establishing a connection with the low-energy short-range wireless network device side of the AMB device 122-1, at 208, the EDL device 124-11 switches to advertise mode and begins broadcasting advertising packets during an advertising window to all of the downlink low-energy short-range wireless network devices, i.e., EDL device 124-12. However, as will be appreciated, there may be more than one downlink EDL device 124 of the EDL device 124-11.

As described above, the EDL devices 124 periodically scan for incoming advertising packets. However, an EDL device 124 may not receive an advertising packet during every scan window. This is illustrated in FIG. 2A as block 210, where the EDL device 124-12 scans for incoming advertising packets during a periodic scan window, but does not receive the advertising packet from the EDL device 124-11 until the periodic scan window at 212. After receiving the advertising packet during the periodic scan window at 212, at 214, the EDL device 124-12 establishes a connection with the EDL device 124-11.

After establishing a connection with the EDL device 124-11, at 216, the EDL device 124-12 switches to advertise mode and begins broadcasting advertising packets during an advertising window to all of the downlink low-energy short-range wireless network devices, i.e., EDL device 124-13. However, as will be appreciated, there may be more than one downlink EDL device 124 of the EDL device 124-12.

Like the EDL device 124-12, the EDL device 124-13 scans for incoming advertising packets during periodic scan windows, although it may not receive an advertising packet during every scan window, as illustrated by blocks 218 and 220. During the periodic scan window at 222, however, the EDL device 124-13 receives an advertising packet from the EDL device 124-12. In response, at 224, the EDL device 124-13 establishes a connection with the EDL device 124-12. Thus, each EDL device 124 in the low-energy mesh network 120-1 establishes a connection with at least one uplink device, and may establish a connection with one or more downlink devices. Once each EDL device 124 is connected, the low-energy mesh network 120-1 is formed.

FIG. 2B illustrates an exemplary flow 200B for communicating over a low-energy mesh network, according to at least one aspect of the disclosure. Specifically, FIG. 2B illustrates communications among the WLAN access point 112 and devices of the low-energy mesh network 120-1 of FIG. 1, specifically, the AMB device 122-1 and EDL devices 124-11 to 124-13.

At 242, the WLAN access point 112 receives data to be propagated to one or more EDL devices 124. The data may be received over a wireless communication link, such as from a server 102 or from another WLAN access point 112, input into the WLAN access point 112 via a user interface, accessed from a computer-readable storage medium, such as a universal serial bus (USB) drive, or the like. At 244, the WLAN access point 112 transmits the one or more data packets to the access terminal side of the AMB device 122-1.

The access terminal side of the AMB device 122-1 receives the data packet(s) from the WLAN access point 112 over the WLAN 110, and at 246, the low-energy short-range wireless network device side of the AMB device 122-1 (which may be a BLE device) formats the data into one or more data packets to be transmitted through the low-energy mesh network 120-1. In an aspect, if the low-energy mesh network 120-1 uses routing, then the AMB device 122-1 or an EDL device 124 needs to know the next EDL device 124 in the route of EDL devices 124 to the target EDL device 124. However, if the low-energy mesh network 120-1 uses flooding, then there is no need for the AMB device 122-1 or an EDL device 124 to know the next node. Rather, each node inspects the received data packet(s) to determine whether it is the target, and if it is not (or is not the only target), simply floods the received data packet(s) to all downlink nodes.

Thus, at 248, the low-energy short-range wireless network device side of the AMB device 122-1 floods the data packet(s) to all of the downlink low-energy short-range wireless network devices to which it is connected, i.e., EDL device 124-11. However, as will be appreciated, there may be more than one downlink EDL device 124 of the AMB device 122-1. The AMB device 122-1 floods the data packet(s) over the connection(s) established at 206 of FIG. 2A.

Upon receiving the data packet(s), the EDL device 124-11 inspects the data packet(s) to determine whether or not it is the target, and if it is, whether there are other targets. In the example of FIG. 2B, the EDL device 124-11 is not the target, or is not the only target, and therefore, at 250, floods the data packet(s) to all of the downlink low-energy short-range wireless network devices to which it is connected, i.e., EDL device 124-12. However, as will be appreciated, there may be more than one downlink EDL device 124 of the EDL device 124-11. The EDL device 124-11 floods the data packet(s) over the connection(s) established at 214 of FIG. 2A.

Upon receiving the data packet(s) from EDL device 124-11, the EDL device 124-12 inspects the data packet(s) to determine whether or not it is the target, and if it is, whether there are other targets. In the example of FIG. 2B, the EDL device 124-12 is not the target, or is not the only target, and therefore, at 252, floods the data packet(s) to all of the downlink low-energy short-range wireless network devices to which it is connected, i.e., EDL device 124-13. However, as will be appreciated, there may be more than one downlink EDL device 124 of the EDL device 124-12. The EDL device 124-12 floods the data packet(s) over the connection(s) established at 224 of FIG. 2A.

Upon receiving the data packet(s) from the EDL device 124-12, the EDL device 124-13 inspects the data packet(s) and determines that it is the target of the data packet(s). Accordingly, at 254, the EDL device 124-13 updates its display with the information in the received data packet(s).

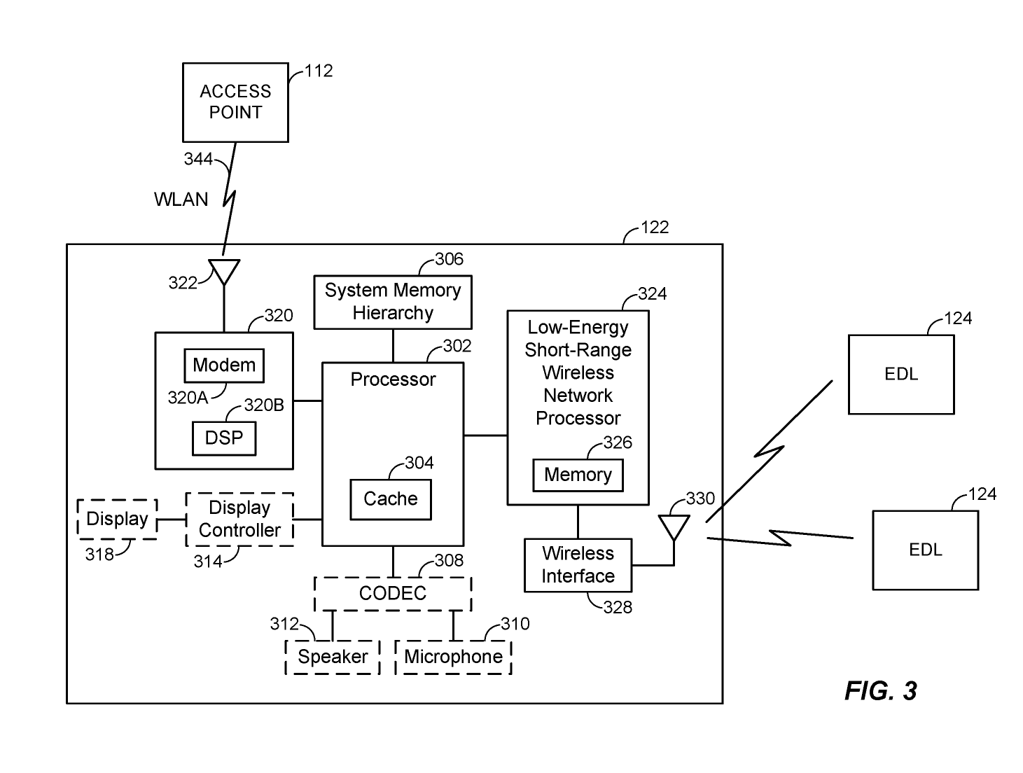

FIG. 3 illustrates an exemplary AMB device 122 according to at least one aspect of the disclosure. A main processor 302 for the AMB device 122 runs applications that cause the AMB device 122 to perform the AMB device functionality described herein, and includes a cache memory 304 as well as an interface to store and retrieve data and instructions from off-chip memory, represented in FIG. 3 as the system memory hierarchy 306. The system memory hierarchy 306 may comprise various volatile and non-volatile memory systems.

The AMB device 122 is capable of interfacing with wireless local area networks by way of a communication functional unit 320 and an antenna 322. The communication functional unit 320 is illustrated as comprising a modem 320A and a digital signal processor (DSP) 320B, although in practice other kinds of modules may be employed, all or some such modules may be integrated on a single chip, and some of the modules may be integrated with the processor 302. In the example of FIG. 3, the AMB device 122 has a WLAN link 344 to the WLAN access point 112, which provides access to the server 102 (not shown).

In an aspect, the main processor 302 may implement a low-energy short-range wireless network protocol stack, such as a BLE protocol stack, in which instructions for performing some or all of the protocol stack are stored in the system memory hierarchy 306. However, in the example of FIG. 3, a separate chip or an embedded hardware core, shown as a low-energy short-range wireless network processor 324, implements the portions of the protocol stack to perform the low-energy short-range wireless network AMB device operations indicated in FIGS. 2A and 2B. The low-energy short-range wireless network processor 324 comprises a memory 326, shown as an on-chip memory, although the memory 326 may be part of a memory hierarchy in which some memory also resides off-chip. The wireless interface 328 provides an interface to the antenna 330, suitable for operating in the designated frequency spectrum utilized by the low-energy short-range wireless network. Communication may be made to any number of low-energy short-range wireless network capable devices, such as one or more EDL devices 124 (two in the example of FIG. 3, but there may be more or fewer than two). The instructions for implementing some or all of the low-energy short-range wireless network AMB device operations indicated in FIGS. 2A and 2B may be stored in a memory, such as memory 326. The memory 326 may be referred to as a non-transitory computer readable medium.

As illustrated in FIG. 3, the AMB device 122 includes both a communication functional unit 320 that permits the AMB device 122 to act as an access terminal to the WLAN access point 112, and a low-energy short-range wireless network processor 324 and wireless interface 328 that together permit the AMB device 122 to act as a low-energy mesh network node in a low-energy mesh network 120. More specifically, the AMB device 122 may receive update information for an EDL device 124 from an WLAN access point 112 via the communication functional unit 320. The AMB device 122 may package the update information into one or more data packets configured to be transmitted over the low-energy mesh network 120 and, after establishing a connection with all downlink EDL devices 124, transmit the data packet(s) to the downlink EDL devices 124 using the low-energy short-range wireless network processor 324 and wireless interface 328.

The AMB device 122 may optionally include a user interface. As shown in FIG. 3, the AMB device 122 may include a CODEC (Coder-Decoder) 308 for interfacing with a microphone 310 and a speaker 312. A display controller 314 provides an interface to a display 318 so that the user may interact with the AMB device 122.

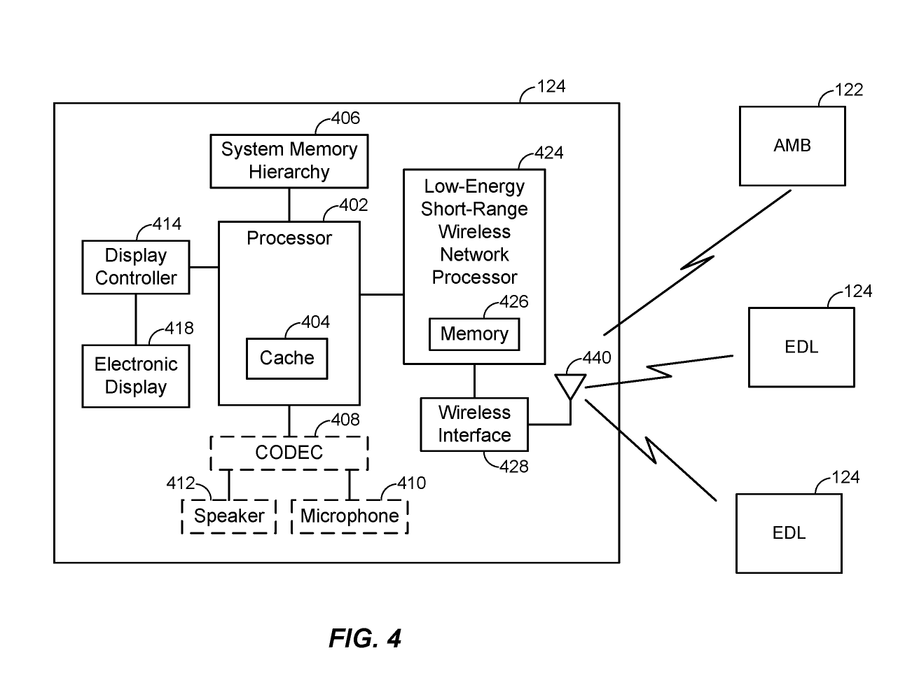

FIG. 4 illustrates an exemplary EDL device 124 according to at least one aspect of the disclosure. A main processor 402 for the EDL device 124 runs applications that cause the EDL device 124 to perform the EDL device functionality described herein, and includes a cache memory 404 as well as an interface to store and retrieve data and instructions from off-chip memory, represented in FIG. 4 as the system memory hierarchy 406. The system memory hierarchy 406 may comprise various volatile and non-volatile memory systems.

In an aspect, the main processor 402 may implement a low-energy short-range wireless network protocol stack, such as a BLE protocol stack, in which instructions for performing some or all of the protocol stack are stored in the system memory hierarchy 406. However, in the example of FIG. 4, a separate chip or an embedded hardware core, shown as a low-energy short-range wireless network processor 424, implements the portions of the protocol stack to perform the low-energy short-range wireless network EDL device operations indicated in FIGS. 2A and 2B. The low-energy short-range wireless network processor 424 comprises a memory 426, shown as an on-chip memory, although the memory 426 may be part of a memory hierarchy in which some memory also resides off-chip. The wireless interface 428 provides an interface to the antenna 430, suitable for operating in the designated frequency spectrum utilized by the low-energy short-range wireless network. Communication may be made to any number of low-energy short-range wireless network capable devices, such as an AMB device 122 and one or more EDL devices 124 (two in the example of FIG. 4, but there may be more or fewer than two). The instructions for implementing some or all of the low-energy short-range wireless network EDL device operations indicated in FIGS. 2A and 2B may be stored in a memory, such as memory 426. The memory 426 may be referred to as a non-transitory computer readable medium.

The EDL device 124 further includes a display controller 414 that provides an interface to an electronic display 418. In an aspect, the electronic display 418 may be a liquid crystal display (LCD), a light-emitting diode (LED) display, an electronic paper (e-paper) display, which reads like ink on paper and does not use energy in the static state, or the like. The electronic display 418 may display information about a particular product, such as the name, brand, price, item number, etc. The EDL device 124 may optionally include a CODEC 408 for interfacing with a microphone 410 and a speaker 412.

The EDL device 124 may receive one or more data packets from an AMB device 122 or an uplink EDL device 124 via the low-energy short-range wireless network processor 424 and wireless interface 428. The one or more data packets may carry update information for an EDL device 124 in the payload(s) of the data packet(s). If the update information is destined for the EDL device 124, the EDL device 124 may update the display electronic 418 with the received update information. If the update information is destined for a different EDL device 124, or an additional EDL device 124, the EDL device 124 can propagate the one or more data packets to all downlink EDL devices 124 via the low-energy short-range wireless network processor 324 and wireless interface 328.

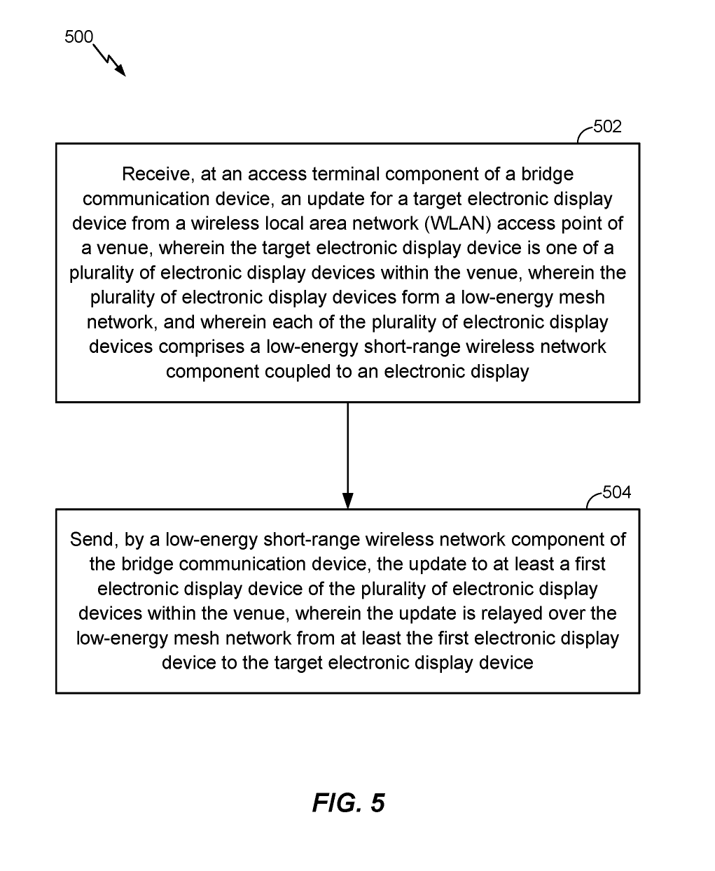

FIG. 5 illustrates an exemplary flow 500 for relaying an update to a target electronic display device (e.g., an EDL device 124) within a venue. The flow 500 may be performed by a bridge communication device, such as an AMB device 122.

At 502, an access terminal component (e.g., communication functional unit 320) of the bridge communication device receives the update for the target electronic display device from a WLAN access point (e.g., WLAN access point 112) of the venue, as at 244 of FIG. 2B. The target electronic display device may be one of a plurality of electronic display devices within the venue. In an aspect, the plurality of electronic display devices may form a low-energy mesh network (e.g., a low-energy mesh network 120). In an aspect, each of the plurality of electronic display devices may comprise a low-energy short-range wireless network component (e.g., low-energy short-range wireless network processor 424) coupled to an electronic display (e.g., electronic display 418).

At 504, a low-energy short-range wireless network component (e.g., low-energy short-range wireless network processor 324) of the bridge communication device may send the update to at least a first electronic display device of the plurality of electronic display devices within the venue, as at 248 of FIG. 2B. In an aspect, the update may be relayed over the low-energy mesh network from at least the first electronic display device to the target electronic display device.

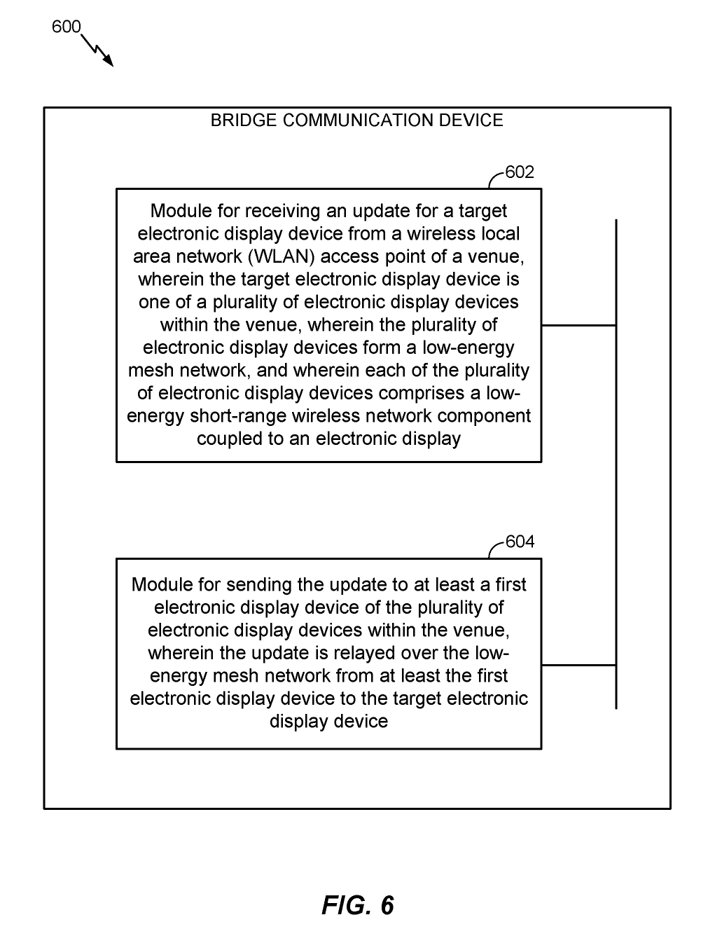

FIG. 6 illustrates an example bridge communication device 600 represented as a series of interrelated functional modules. A module for receiving 602 may correspond at least in some aspects to, for example, an access terminal component, such as communication functional unit 320, as discussed herein. A module for sending 604 may correspond at least in some aspects to, for example, a low-energy short-range wireless network component, such as low-energy short-range wireless network processor 324, as discussed herein.

The functionality of the modules of FIG. 6 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 6, as well as other components and functions described herein, may be implemented using any suitable means. Such means also may be implemented, at least in part, using corresponding structure as taught herein. For example, the components described above in conjunction with the “module for” components of FIG. 6 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an AMB device and/or an EDL device. In the alternative, the processor and the storage medium may reside as discrete components in a AMB device and/or an EDL device.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of relaying an update to a target electronic display device within a venue, comprising:
receiving, at an access terminal component of a bridge communication device, the update for the target electronic display device from a wireless local area network (WLAN) access point of the venue, wherein the target electronic display device is one of a plurality of electronic display devices within the venue, wherein the plurality of electronic display devices form a low-energy mesh network, and wherein each of the plurality of electronic display devices comprises a low-energy short-range wireless network component coupled to an electronic display; and
sending, by a low-energy short-range wireless network component of the bridge communication device, the update to at least a first electronic display device of the plurality of electronic display devices within the venue, wherein the update is relayed over the low-energy mesh network from at least the first electronic display device to the target electronic display device.

2. The method of claim 1, wherein the update comprises information to be displayed on the electronic display of the target electronic display device.

3. The method of claim 2, wherein the information is packaged in a payload of a data packet configured to be transmitted over the low-energy mesh network.

4. The method of claim 2, wherein the information is packaged in a plurality of payloads of a plurality of data packets configured to be transmitted over the low-energy mesh network.

5. The method of claim 1, wherein the update includes information to be displayed by multiple electronic display devices of the plurality of electronic display devices.

6. The method of claim 1, further comprising:
receiving, at the access terminal component of the bridge communication device from the WLAN access point, a second update for a second target electronic display device of the plurality of electronic display devices; and
sending, by the low-energy short-range wireless network component of the bridge communication device, the second update to at least the first electronic display device of the plurality of electronic display devices, wherein the second update is relayed over the low-energy mesh network from at least the first electronic display device to the second target electronic display device.

7. The method of claim 6, wherein the second update comprises different information than the update, and wherein the second target electronic display device is different than the target electronic display device.

8. The method of claim 1, wherein the low-energy mesh network comprises a QCSR Mesh™ network.

9. The method of claim 1, wherein the low-energy short-range wireless network component of each of the plurality of electronic display devices comprises a Bluetooth® Low-Energy (BLE) circuit.

10. The method of claim 1, wherein the electronic display of each of the plurality of electronic display devices comprises an electronic paper display.

11. The method of claim 1, wherein the access terminal component of the bridge communication device comprises a WiFi access terminal, and wherein the low-energy short-range wireless network component of the bridge communication device comprises a Bluetooth® Low-Energy (BLE) circuit.

12. A bridge communication device for relaying an update to a target electronic display device within a venue, comprising:
an access terminal component configured to receive the update for the target electronic display device from a wireless local area network (WLAN) access point of the venue, wherein the target electronic display device is one of a plurality of electronic display devices within the venue, wherein the plurality of electronic display devices form a low-energy mesh network, and wherein each of the plurality of electronic display devices comprises a low-energy short-range wireless network component coupled to an electronic display; and
a low-energy short-range wireless network component configured to send the update to at least a first electronic display device of the plurality of electronic display devices within the venue, wherein the update is relayed over the low-energy mesh network from at least the first electronic display device to the target electronic display device.

13. The bridge communication device of claim 12, wherein the update comprises information to be displayed on the electronic display of the target electronic display device.

14. The bridge communication device of claim 13, wherein the information is packaged in a payload of a data packet configured to be transmitted over the low-energy mesh network.

15. The bridge communication device of claim 13, wherein the information is packaged in a plurality of payloads of a plurality of data packets configured to be transmitted over the low-energy mesh network.

16. The bridge communication device of claim 12, further comprising:
receiving, at the access terminal component of the bridge communication device from the WLAN access point, a second update for a second target electronic display device of the plurality of electronic display devices; and
sending, by the low-energy short-range wireless network component of the bridge communication device, the second update to at least the first electronic display device of the plurality of electronic display devices, wherein the second update is relayed over the low-energy mesh network from at least the first electronic display device to the second target electronic display device.

17. The bridge communication device of claim 12, wherein the low-energy mesh network comprises a QCSR Mesh™ network.

18. The bridge communication device of claim 12, wherein the low-energy short-range wireless network component of each of the plurality of electronic display devices comprises a Bluetooth® Low-Energy (BLE) circuit.

19. The bridge communication device of claim 12, wherein the access terminal component of the bridge communication device comprises a WiFi access terminal, and wherein the low-energy short-range wireless network component of the bridge communication device comprises a Bluetooth® Low-Energy (BLE) circuit.

20. A non-transitory computer-readable medium storing computer-executable instructions for relaying an update to a target electronic display device within a venue, the computer-executable instructions comprising:
at least one instruction to cause an access terminal component of a bridge communication device to receive the update for the target electronic display device from a wireless local area network (WLAN) access point of the venue, wherein the target electronic display device is one of a plurality of electronic display devices within the venue, wherein the plurality of electronic display devices form a low-energy mesh network, and wherein each of the plurality of electronic display devices comprises a low-energy short-range wireless network component coupled to an electronic display; and
at least one instruction to cause a low-energy short-range wireless network component of the bridge communication device to send the update to at least a first electronic display device of the plurality of electronic display devices within the venue, wherein the update is relayed over the low-energy mesh network from at least the first electronic display device to the target electronic display device.
